(19) United States
(12) Patent Application Publication
(10) Pub. No.: US 2005/0000348 A1
(43) Pub. Date: Jan. 6, 2005

(54) Support for a musical instrument

(76) Inventor: Dean Ronald Workman, Queensland (AU)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/846,387

(22) Filed: May 14, 2004

Related U.S. Application Data
(63) Continuation of application No. PCT/AU02/01385, filed on Oct. 11, 2002.

(30) Foreign Application Priority Data
Nov. 15, 2001 (AU) PR 8935

(51) Int. Cl. G10D 3/00; G10G 5/00

(52) U.S. Cl. 84/327

(57) ABSTRACT

A support for a musical instrument is manufactured from a soft pliable material and is adapted to be attached to a vertical supporting surface. The fingerboard or neck of a musical instrument, when stood upright on the floor below, can be inserted in a socket provided on the support when the instrument is not in use to thus provide a convenient and safe means of storage.

### CROSS-REFERENCE TO RELATED APPLICATIONS

This application is a continuation of International Application No. PCT/AU02/01385, filed Oct. 11, 2002, which was published in the English language on May 22, 2003, under International Publication No. WO 03/042970 A1 and the disclosure of which is incorporated herein by reference.

### BACKGROUND OF THE INVENTION

This invention relates to musical instrument supports.

This invention has particular but not exclusive application to providing support and stability to musical instruments by way of leaning the said instruments into or against the instrument support which is positioned against and secured to a rigid or stable surface or object.

Many musicians who use stringed instruments, and particularly those who play guitar and perform live, require a way of supporting their instrument while they are not playing it. This has traditionally been achieved by way of the standard guitar stand, however there are several problems related to the standard guitar stand. For example; they are unstable, they are awkward to transport and set up, they take up a lot of room on stage, and they are often forgotten when selecting equipment to take as part of a live performance. They are an inconvenient item to store, transport and use.

The problems with traditional guitar stands are discussed in U.S. Pat. No. 6,120,375 which discloses a solution by the way of a stand for attachment to the base of a guitar.

### BRIEF SUMMARY OF THE INVENTION

The present invention also aims to alleviate the above situations and to provide a support apparatus which will be reliable, convenient, and efficient in use.

According to the present invention, there is provided a support for a musical instrument comprising a body having a planar base and on an opposite upper side an opening leading to an internal socket which is wider and deeper than the opening and an attachment secured to the planar base which enables the support to be releasably attached to a flat surface characterized in that the body is molded from a soft pliable material capable of stretching to allow the insertion and removal of a limb of a musical instrument such as the fingerboard of a stringed instrument into and from the socket and without damaging the instrument.

The attachment means can comprise two sheets of a hook and loop fastener, such as the fabric hook and loop fasteners commercially available under the trademark VELCRO®, a first sheet of which is fixed to the planar base of the support and a second sheet of which is adapted for fixing to a planar vertical surface.

The width of the opening to the socket can be approximately 10 mm and the width of the socket can be approximately 40 mm.

The surfaces of the body at the opening are chamfered.

The socket is substantially semi-circular.

The support can be approximately 60 mm in depth and 100 mm in width.

One of the fastener sheets can be fixed to the base of the support and extends beyond one end of the support.

The body can be molded in ethylene-vinyl acetate copolymer, such as EVA 45, closed cell foam rubber.

According to a further aspect of the present invention, there is provided a method of supporting an upright musical instrument with respect to an upright structure the method comprising the steps of attaching a support as aforesaid to the structure in a position which is spaced from a supporting floor sufficient distance so that the instrument can be temporarily supported by the support in an upright position.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a side perspective view of a support according to the invention;

FIG. 2 is a front perspective view of an amplifier and shows the positioning of the support of FIG. 1, and

FIG. 3 is a similar perspective view to FIG. 2 showing the support fixed to the side wall of an amplifier and supporting a guitar.

### DETAILED DESCRIPTION OF THE INVENTION

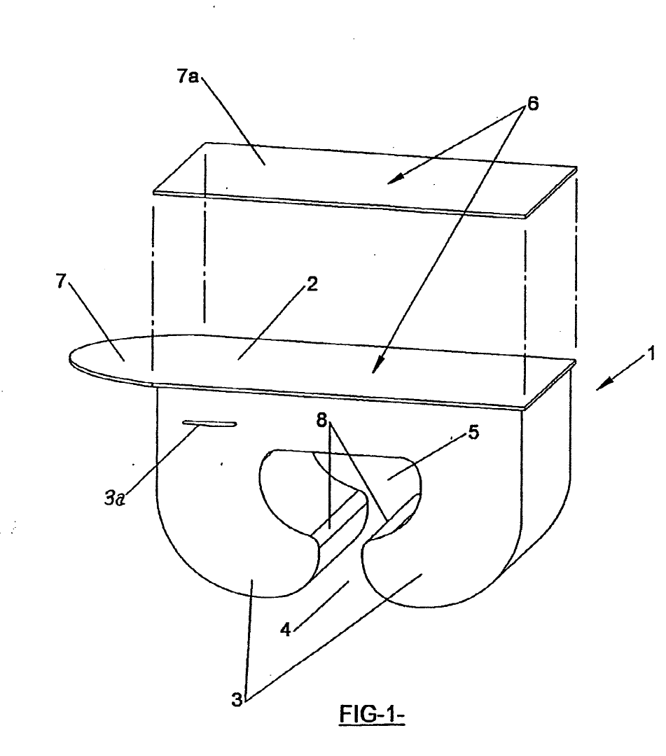

With respect to FIG. 1 of the drawings, a support of the present invention comprises a body generally indicated by arrow 1, having a planar base 2 and on an opposite side 3 an opening 4 leading to a socket 5 which is wider and deeper than the opening.

An attachment generally indicated by arrow 6 enables the support to be releasably attached to a supporting surface.

The body 1 is molded in a soft pliable material capable of stretching to allow the insertion and removal of an elongate limb of a musical instrument into and from the socket 5 to provide support for same.

In the example illustrated, the attachment 6 comprises two sheets 7, 7a of VELCRO® fastener. The first sheet 7 is fixed to the planar base 2 of the support and the second sheet 7a is provided for fixation to a planar vertical surface.

The support is primarily designed for use with a range of musical instruments and as such the opening 4 to the socket is ideally 10 mm wide and the width of the socket can be approximately 40 mm.

The opening 4 to the socket 5 is provided with chamfered surfaces 8.

The shape of the socket is preferably semi-circular and therefore complementary to the fret board of the neck of most forms of string instruments.

The overall depth of the support can be 60 mm and the depth 100 mm.

The VELCRO® sheet 7 has one end which extends beyond one end of the body of the support.

Flat surfaces of the support can be provided with slots 3a for accommodating picks.

The support is preferably molded from EVA 45 closed cell foam rubber, although other materials exhibiting similar characteristics may be used.

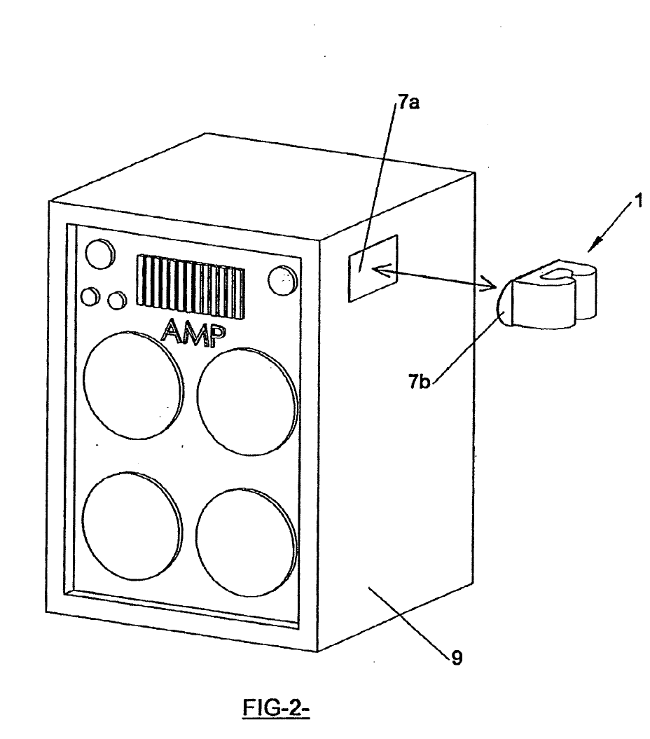

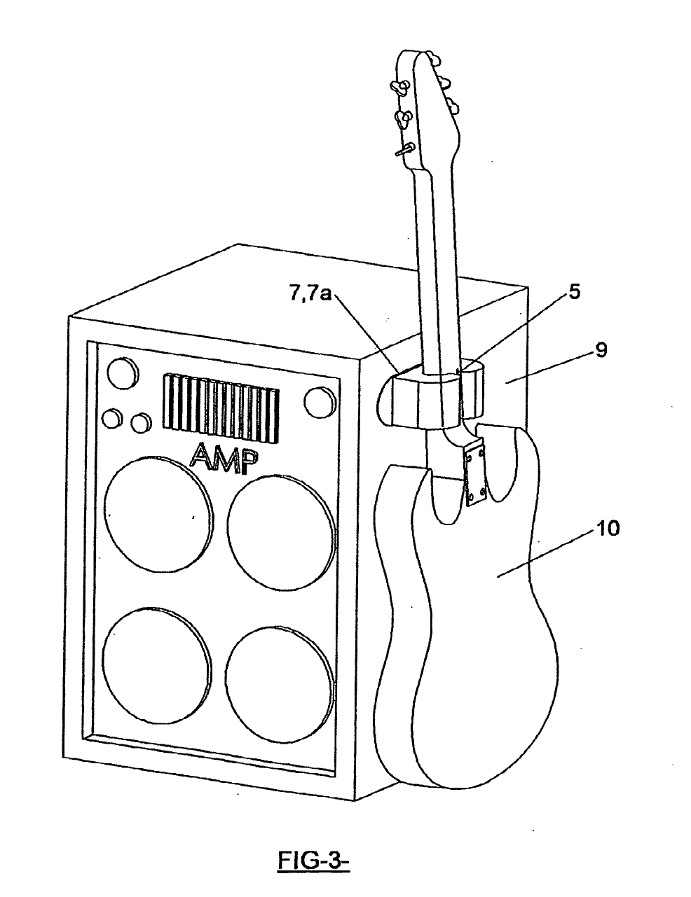

FIGS. 2 and 3 of the drawings show the mounting of the support to a vertical side wall 9 at an amplifier 10.

To attach the support to the amplifier, the fastener strip 7a is fixed to the sidewall of the amplifier at an appropriate elevation.

The support is then fixed to the amplifier by engaging the fastener strip 7 with strip 7a in the manner illustrated.

In use, the fret board of the neck of a musical instrument, such as a guitar 10, is engaged with the socket 5 of the support and the guitar is then conveniently stored when not in use.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A support for a musical instrument comprising a body having a planar base and on an opposite upper side of the body an opening leading to an internal socket which is wider and deeper than the opening, and a fastener secured to the planar base which enables the support to be releasably attached to a flat surface, wherein the body is molded from a soft pliable material capable of stretching to allow insertion and removal of a limb of a musical instrument into and from the socket and without damaging the instrument.

2. The support as claimed in claim 1, wherein the fastener comprises two sheets of a fabric hook and loop fastener, a first sheet of which is fixed to the planar base of the support and a second sheet of which is adapted for fixing to a planar vertical surface.

3. The support as claimed in claim 1, wherein a width of the opening to the socket is approximately 10 mm and a width of the socket is approximately 40 mm.

4. The support as claimed in claim 1, wherein surfaces of the body at the opening are chamfered.

5. The support as claimed in claim 1, wherein the socket is substantially semi-circular.

6. The support as claimed in claim 1, wherein the support is approximately 60 mm in depth and 100 mm in width.

7. The support as claimed in claim 2, where one of the fastener sheets is fixed to the base of the support and extends beyond one end of the support.

8. The support as claimed in claim 1, wherein the body is molded in ethylene-vinyl acetate copolymer closed cell foam rubber.

9. The support as claimed in claim 1, wherein the limb of a musical instrument is a fret board of a stringed instrument.

10. A method of supporting an upright musical instrument with respect to an upright structure, the method comprising the steps of attaching a support as claimed in claim 1 to the structure in a position which is spaced from a supporting floor a sufficient distance so that the instrument is temporarily supported by the support in an upright position.
